(19) United States
(12) Patent Application Publication
(10) Pub. No.: US 2019/0143879 A1
(43) Pub. Date: May 16, 2019

(54) MOTOR VEHICLE WITH CONSPICUITY LAMP CONFIGURED TO INDICATE LOAD

(71) Applicant: Ford Global Technologies, LLC, Dearborn, MI (US)

(72) Inventors: Venkatesh Krishnan, Canton, MI (US); Segundo Baldovino, Novi, MI (US)

(21) Appl. No.: 15/813,242

(22) Filed: Nov. 15, 2017

(51) Int. Cl. B60Q 1/00; G01G 19/12; B60K 28/08; H05B 37/02

(52) U.S. Cl. CPC B60Q 1/0023; G01G 19/12; B60W 2422/20; H05B 37/0245; B60W 2530/10; B60K 28/08

(57) ABSTRACT

A motor vehicle according to an exemplary aspect of the present disclosure includes, among other things, a conspicuity lamp and a controller configured to illuminate the conspicuity lamp in proportion to a load of the motor vehicle. A method is also disclosed.

### TECHNICAL FIELD

This disclosure relates to a motor vehicle including a conspicuity lamp, such as a tail lamp or a center high-mount stop lamp, configured to indicate a load of the motor vehicle.

### BACKGROUND

Motor vehicles are known to include areas for supporting a load during transport. For example, pickup trucks have a cargo box configured to hold a load, and other vehicles have trunks or rear storage compartments for holding a load.

Manufacturers typically set a load capacity, or a maximum rated load, for a particular motor vehicle based on a number of factors, including the potential effect of the load on fuel economy and vehicle handling, as examples. The load capacity may also be set, in part, by state or federal regulations. Commonly, vehicles are unable to indicate the weight of the load to the user. Far less commonly, some vehicles include a display device within the vehicle, such as a vehicle infotainment system, which indicates the weight of the vehicle load.

### SUMMARY

A motor vehicle according to an exemplary aspect of the present disclosure includes, among other things, a conspicuity lamp and a controller configured to illuminate the conspicuity lamp in proportion to a load of the motor vehicle.

In a further non-limiting embodiment of the foregoing motor vehicle, the controller is configured to illuminate a surface area of the conspicuity lamp in proportion to the load of the motor vehicle.

In a further non-limiting embodiment of any of the foregoing motor vehicles, the surface area of the conspicuity lamp is divided into sections, and the controller is configured to illuminate a number of sections of the conspicuity lamp in proportion to the load of the motor vehicle.

In a further non-limiting embodiment of any of the foregoing motor vehicles, the controller illuminates none of the sections of the conspicuity lamp when the load of the motor vehicle is below a predetermined threshold.

In a further non-limiting embodiment of any of the foregoing motor vehicles, the controller illuminates all of the sections of the conspicuity lamp when the load of the motor vehicle meets or exceeds a maximum rated load for the motor vehicle.

In a further non-limiting embodiment of any of the foregoing motor vehicles, the controller prevents normal vehicle operation when the load of the motor vehicle meets or exceeds the maximum rated load for the motor vehicle.

In a further non-limiting embodiment of any of the foregoing motor vehicles, the controller illuminates the conspicuity lamp in proportion to a load of the motor vehicle and as the load of the motor vehicle relates to a maximum rated load of the motor vehicle.

In a further non-limiting embodiment of any of the foregoing motor vehicles, the motor vehicle includes a sensor configured to generate a signal indicative of the load of the motor vehicle.

In a further non-limiting embodiment of any of the foregoing motor vehicles, the sensor includes a strain gauge mounted adjacent a rear axle of the motor vehicle.

In a further non-limiting embodiment of any of the foregoing motor vehicles, the sensor includes a transducer mounted adjacent a coil spring.

In a further non-limiting embodiment of any of the foregoing motor vehicles, the conspicuity lamp is one of a tail lamp and a center high-mount stop lamp.

In a further non-limiting embodiment of any of the foregoing motor vehicles, the motor vehicle is a pickup truck, and the load of the motor vehicle is a load in a cargo box of the pickup truck.

A method according to an exemplary aspect of the present disclosure includes, among other things, illuminating a conspicuity lamp in proportion to a load of a motor vehicle.

In a further non-limiting embodiment of the foregoing methods, the step of illuminating the conspicuity lamp includes illuminating a surface area of the conspicuity lamp in proportion to the load of the motor vehicle.

In a further non-limiting embodiment of any of the foregoing methods, the surface area of the conspicuity lamp is divided into sections, and a number of sections of the conspicuity lamp are illuminated in proportion to the load of the motor vehicle.

In a further non-limiting embodiment of any of the foregoing methods, none of the sections of the conspicuity lamp are illuminated when the load of the motor vehicle is below a predetermined threshold.

In a further non-limiting embodiment of any of the foregoing methods, all of the sections of the conspicuity lamp are illuminated when the load of the motor vehicle meets or exceeds a maximum rated load for the motor vehicle.

In a further non-limiting embodiment of any of the foregoing methods, the method further includes preventing normal vehicle operation when the load of the motor vehicle meets or exceeds the maximum rated load for the motor vehicle.

In a further non-limiting embodiment of any of the foregoing methods, the load of the motor vehicle is determined based on a signal from a sensor. The sensor includes one of a strain gauge and a transducer.

In a further non-limiting embodiment of any of the foregoing methods, the conspicuity lamp is one of a tail lamp and a center high-mount stop lamp.

### BRIEF DESCRIPTION OF THE DRAWINGS

FIG. 1 is a rear-perspective view of a motor vehicle, which in this example is a pickup truck. A front-end loader is adjacent the pickup truck.

FIG. 2 is a close-up view of the encircled area in FIG. 1, and in particular illustrates the detail of an example conspicuity lamp.

FIG. 3 illustrates a portion of a vehicle suspension system and an example load sensor arrangement.

FIG. 4 illustrates another example load sensor arrangement.

FIG. 5 is a flow chart representative of an example method.

FIGS. 6A-6E illustrate an example conspicuity lamp with various sections of the lamp illuminated. In FIGS. 6A-6E, the conspicuity lamp is a tail lamp.

FIG. 6A illustrates the tail lamp without any sections illuminated.

FIG. 6B illustrates the tail lamp with a first section illuminated.

FIG. 6C illustrates the tail lamp with first and second sections illuminated.

FIG. 6D illustrates the tail lamp with first, second, and third sections illuminated.

FIG. 6E illustrates the tail lamp with first, second, third, and fourth sections illuminated.

FIGS. 7A-7E illustrate another example conspicuity lamp with various sections of the lamp illuminated. In FIGS. 7A-7E, the conspicuity lamp is a center high-mount stop lamp.

FIG. 7A illustrates the center high-mount stop lamp without any sections illuminated.

FIG. 7B illustrates the center high-mount stop lamp with a first section illuminated.

FIG. 7C illustrates the center high-mount stop lamp with first and second sections illuminated.

FIG. 7D illustrates the center high-mount stop lamp with first, second, and third sections illuminated.

FIG. 7E illustrates the center high-mount stop lamp with first, second, third, and fourth sections illuminated.

### DETAILED DESCRIPTION

This disclosure relates to a motor vehicle, such as a pickup truck, including a conspicuity lamp and a controller configured to illuminate the conspicuity lamp in proportion to a load of the motor vehicle. The conspicuity lamp may be a tail lamp or a center high-mount stop lamp, as examples, which is viewable from an exterior of the vehicle. By illuminating the conspicuity lamp in proportion to the load of the vehicle, a user can conveniently discern the weight of the load during the loading process (i.e., without the need to consult a vehicle infotainment system or separate display panel). The conspicuity lamp provides the user with real time information about the load, and allows the user to make informed decisions about the load, including whether it is safe to continue loading the vehicle or whether to reduce the load, as examples.

FIG. 1 illustrates a motor vehicle 10, which in this example is a pickup truck. The vehicle 10 includes a passenger cabin 12 and a cargo box 14. The vehicle 10 further includes a tailgate 16 configured to move between an open position and a closed position, the latter of which is shown in FIG. 1, to allow access to the cargo box 14. The cargo box 14 is configured to support a load during transport by the vehicle 10. An example load 18 is shown in FIG. 1. In this example, the load 18 is a load of dirt, which was loaded into the cargo box 14 by a front-end loader 20.

This disclosure is not limited to any particular type of vehicle. For example, this disclosure also extends to vehicles such as vans, sport utility vehicles (SUVs), sedans, sports cars, etc. Additionally, this disclosure is not limited to dirt loads, and extends to other types of loads, including groceries, furniture, equipment, wood, steel, gravel, etc., or a combination of different types of loads.

The vehicle 10 includes a plurality of conspicuity lamps, in this example. Conspicuity lamps are lamps that make a vehicle conspicuous and visible with respect to its presence, position, direction of travel, change in direction, and/or deceleration. Among other conspicuity lamps, the vehicle 10 includes first and second tail lamps 22, 24, and a center high-mount stop lamp 26 (CHMSL).

The conspicuity lamps are electrically coupled to a controller 28. The controller 28 is shown schematically in the figures. It should be understood that the controller 28 could be part of an overall vehicle control module, such as a vehicle system controller (VSC), or may be part of a body control module (BCM). Alternatively, the controller 28 may be a stand-alone controller separate from the VSC and the BCM. Further, the controller 28 may be programmed with executable instructions for interfacing with and operating the various components of the vehicle 10. The controller 28 additionally includes a processing unit and non-transitory memory for executing the various control strategies and modes of the vehicle system.

Among other functions, the controller 28 is configured to selectively activate one or more of the conspicuity lamps in proportion to a weight of the load 18 of the vehicle 10. In one example, the controller 28 is configured to illuminate a surface area of the conspicuity lamps in proportion to the weight of the load 18. That is, as the weight of the load 18 increases, the controller 28 illuminates an increased amount of the surface area of the conspicuity lamps. In another example, the controller 28 is configured to adjust the luminance (i.e., brightness) of the conspicuity lamps in proportion to the weight of the load 18.

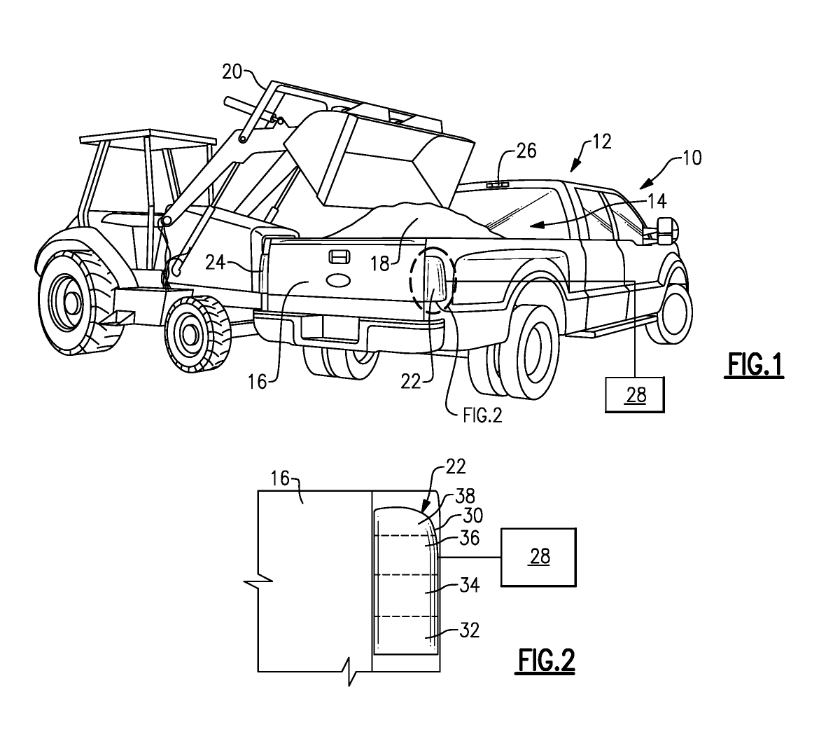

FIG. 2 illustrates one of the conspicuity lamps in detail. Specifically, FIG. 2 illustrates the first tail lamp 22. In the illustrated example, the controller 28 is configured to illuminate the surface area of the first tail lamp 22 in proportion to the weight of the load 18. In this example, the first tail lamp 22 has a surface area surrounded by a perimeter 30, and the surface area of the first tail lamp 22 can be selectively illuminated by the controller 28. In one example, within the perimeter 30, the first tail lamp 22 includes a plurality of lights, such as light emitting diodes (LEDs), which can be individually activated by the controller 28. The controller 28 is configured to selectively illuminate various portions of the surface area of the first tail lamp 22. It should be understood that the lights may be different colors, such as white or red, or may be the same color.

In one particular example of this disclosure, the surface area of the first tail lamp 22 is divided into sections, and the controller 28 is configured to selectively illuminate the sections in proportion to the load of the motor vehicle. With reference to the example of FIG. 2, the first tail lamp 22 includes first, second, third, and fourth sections 32, 34, 36, 38. The first, second, third, and fourth sections 32, 34, 36, 38 are arranged vertically relative to one another. In other examples, the first tail lamp 22 could include sections that are arranged horizontally relative to one another. The controller 28 is configured to selectively activate the first, second, third, and fourth sections 32, 34, 36, 38 in proportion to a weight of the load 18. For example, if there is no load, then none of the first, second, third, and fourth sections 32, 34, 36, 38 would be illuminated. On the other hand, if a maximum rated vehicle load is reached, each of the first, second, third, and fourth sections 32, 34, 36, 38 would be illuminated.

While the first tail lamp 22 includes four discrete sections 32, 34, 36, 38, it should be understood that this disclosure extends to conspicuity lamps that include any number of sections. Additionally, while the sections 32, 34, 36, 38 are substantially the same size, the sections could have different sizes. Further, this disclosure extends to conspicuity lamps without discrete sections, but which are still configured to have a variable amount of surface area illuminated in proportion to a load. While only the first tail lamp 22 is shown in FIG. 2, it should be understood that other conspicuity lamps of the vehicle 10, including the second tail lamp 24 and the center high-mount stop lamp 26, may be arranged substantially similar to the first tail lamp 22 and configured to function in substantially the same way.

In order to determine the weight of the load 18, the controller 28 is electrically coupled to one or more sensors. In one example, sensors are mounted adjacent components of the vehicle suspension system. As the load 18 is loaded into the vehicle 10, the vehicle suspension system reacts to the load 18 and the sensors generate signals that can be interpreted by the controller 28 to determine the weight of the load 18.

FIG. 3 illustrates a portion a vehicle suspension system, which includes a coil spring 40 adjacent a rear axle 42 of the vehicle 10. A sensor 44 is mounted to the coil spring 40 to determine the movement of the coil spring 40, such as the movement brought about by the weight of the load 18. The sensor 44 includes a transducer 46, such as an ultrasonic transducer, mounted to the coil spring 40. A target 48 is also mounted adjacent the coil spring 40, and the transducer 46 generates a signal indicative of the distance between the transducer 46 and the target 48. The controller 28 is configured to use that signal, together with the spring rate of the coil spring 40, to determine the weight of the load 18.

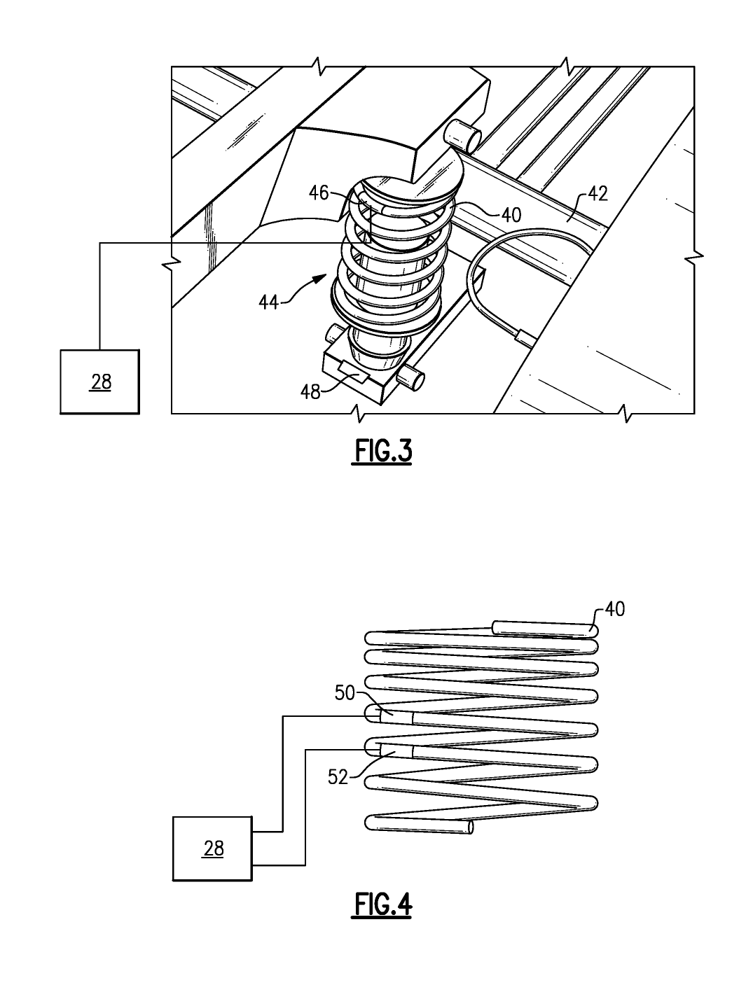

This disclosure is not limited to ultrasonic transducers. To this end, in an alternative embodiment, one or more strain gauges could be used to determine the weight of the load 18. In one such example, shown in FIG. 4, first and second strain gauges 50, 52 are mounted to the coil spring 40. The first and second strain gauges 50, 52 are mounted to adjacent turns of the coil spring 40. The controller 28 is configured to interpret the signals from the first and second strain gauges 50, 52 to determine a weight of the load 18. The first and second strain gauges 50, 52 may be electrically coupled to form a Wheatstone bridge circuit, in one example. Alternatively or additionally, a coil spring on an opposite side of the vehicle 10 may include additional strain gauges arranged substantially similar to those shown in FIG. 4, and may be electrically coupled together with the first and second strain gauges 50, 52 to form a Wheatstone bridge circuit. While strain gauges and transducers are specifically discussed herein, this disclosure extends to other sensor types.

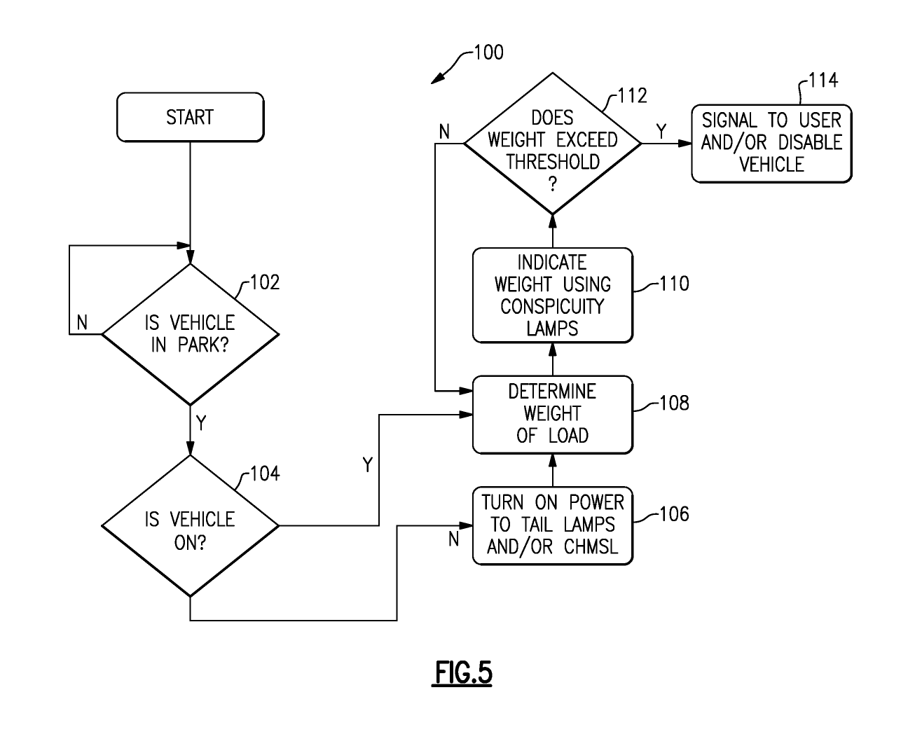

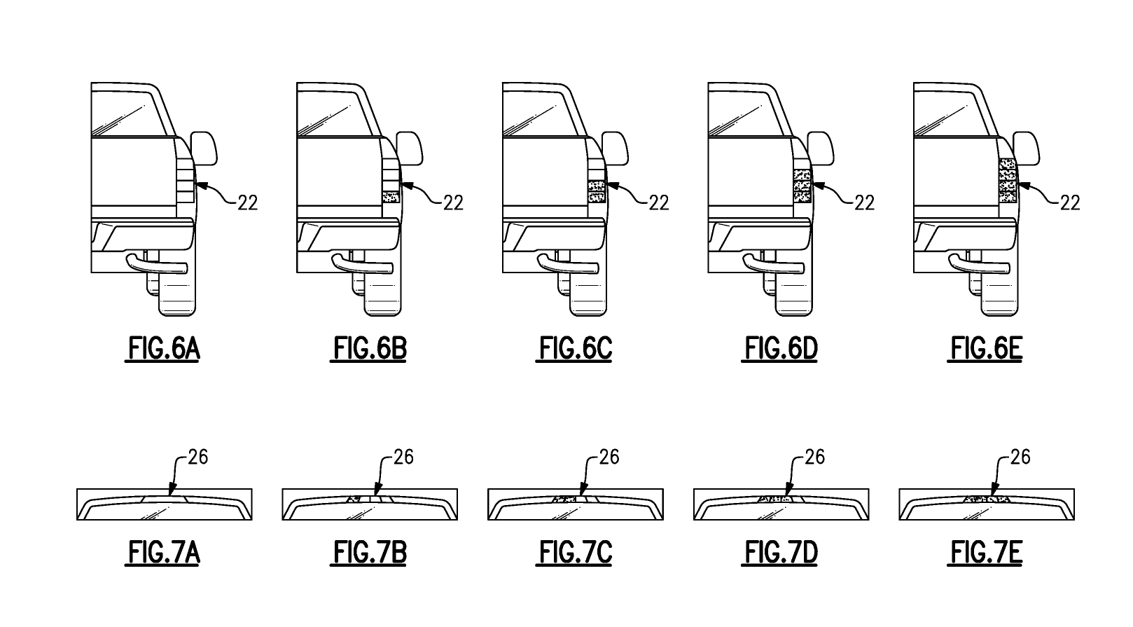

FIG. 5 is a flow chart representative of a method 100 of this disclosure. In particular, using the method 100, the conspicuity lamps of the vehicle 10 can be illuminated in proportion to the weight of the load 18. It should be understood that the method 100 is performed by the components discussed above, including the controller 28. Further, FIGS. 6A-6E and 7A-7E illustrate an exemplary way in which the conspicuity lamps are illuminated in proportion to the weight of the load 18, as will be discussed below.

With reference to FIG. 5, the method 100 begins, at 102, with the controller 28 determining whether the vehicle 10 is in park. When in park, a load may be loaded into the vehicle 10. If the vehicle 10 is in park, the controller 28 next determines whether the vehicle 10 is on, at 104. At this point, it is worth noting that this disclosure extends to all types of vehicles, including electrified vehicles and vehicles that are powered solely by an internal combustion engine. If the vehicle 10 is not on, power is turned on to the conspicuity lamps and the controller 28, at 106, from the vehicle battery, for example. In this respect, the disclosed system may be referred to as a powered at all times system, or a PAAT system. Thus, a user can benefit from this disclosure even when the vehicle 10 is off.

Next, at 108, the controller 28 determines the weight of the load 18 based on information from one or more sensors, such as those described relative to FIGS. 3 and 4. The controller 28 then expresses the determined weight by illuminating the conspicuity lamps in proportion to the weight, at 110. In addition to illuminating the conspicuity lamps, the controller 28 may also display the weight of the load 18 using the vehicle infotainment system, to provide a user with a more precise weight measurement.

FIGS. 6A-6E illustrate the way in which the controller 28 illuminates the first tail lamp 22 in proportion to the weight of the load, and FIGS. 7A-7E illustrate the way in which the controller 28 illuminates the center high-mount stop lamp 26 in proportion to the weight of the load. The first tail lamp 22 is discussed in detail relative to FIG. 2, and it should be understood that the center high-mount stop lamp 26 is arranged substantially similar to the first tail lamp, except that the sections of the center-high mount stop lamp 26 are arranged horizontally, in one example. Again, while not shown in FIG. 6A-6E or 7A-7E, it should be understood that the second tail lamp 24 would function substantially similar to the first tail lamp 22.

FIGS. 6A and 7A represent conditions where there is no load, or wherein the weight of the load 18 is below a predetermined minimum threshold. In those instances, none of the sections of the conspicuity lamps are illuminated. Moving to FIGS. 6B and 7B, only a first section of the conspicuity lamps is illuminated, such as the first section 32 (FIG. 2), which indicates to the user that the weight of the load 18 has begun to register, but it is safe to keep loading. In FIGS. 6C and 7C, first and second sections of the conspicuity lamps are illuminated, such as the first and second sections 32, 34 (FIG. 2), indicating that the load has increased relative to FIGS. 6B and 7B, but, again, it is safe to keep loading. In FIGS. 6D and 7D, three sections of the conspicuity lamps are illuminated (i.e., sections 32, 34, 36 in FIG. 2), which indicates to the user that a maximum rated load for the vehicle has not yet been reached, but that the user should cease loading. If the maximum rated load for the vehicle is reached, at 112, all sections of the conspicuity lamps are illuminated (i.e., sections 32, 34, 36, 38 in FIG. 2), as shown in FIGS. 6E and 7E. This indicates to the user that the weight of the load 18 is too high, and that the load 18 needs to be reduced. Additionally, at 114, the controller 28 may initiate other signals to the user, such as flashing the conspicuity lamps, activating the vehicle horn, and/or disabling the vehicle 10. Regarding the latter example, when the load 18 is too heavy, the controller 28 may prevent normal vehicle operation, which prevents the vehicle 10 from being driven, until the load 18 is reduced.

The controller 28 is programmed with the maximum rated load of the vehicle 10. Depending on the vehicle type, the maximum rated load may differ. As such, the controller 28 is programmed to illuminate the conspicuity lamps in proportion the weight of the load 18 of the vehicle 10, and as that weight relates to the maximum rated load.

Further, while FIGS. 6A-6E and 7A-7E are discussed relative to the method 100, it should be understood that the controller 28 may be configured to illuminate one or more of the tail lamps 22, 24 and the center high-mount stop lamp 26 during the method 100.

It should be understood that terms such as “about,” “substantially,” and “generally” are not intended to be boundaryless terms, and should be interpreted consistent with the way one skilled in the art would interpret those terms. Further, directional terms such as “vertical,” “horizontal,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a conspicuity lamp; and
a controller configured to illuminate the conspicuity lamp in proportion to a load of the motor vehicle.

2. The motor vehicle as recited in claim 1, wherein the controller is configured to illuminate a surface area of the conspicuity lamp in proportion to the load of the motor vehicle.

3. The motor vehicle as recited in claim 2, wherein the surface area of the conspicuity lamp is divided into sections, and wherein the controller is configured to illuminate a number of sections of the conspicuity lamp in proportion to the load of the motor vehicle.

4. The motor vehicle as recited in claim 3, wherein, when the load of the motor vehicle is below a predetermined threshold, the controller illuminates none of the sections of the conspicuity lamp.

5. The motor vehicle as recited in claim 3, wherein, when the load of the motor vehicle meets or exceeds a maximum rated load for the motor vehicle, the controller illuminates all of the sections of the conspicuity lamp.

6. The motor vehicle as recited in claim 5, wherein, when the load of the motor vehicle meets or exceeds the maximum rated load for the motor vehicle, the controller prevents normal vehicle operation.

7. The motor vehicle as recited in claim 1, wherein the controller illuminates the conspicuity lamp in proportion to a load of the motor vehicle and as the load of the motor vehicle relates to a maximum rated load of the motor vehicle.

8. The motor vehicle as recited in claim 1, further comprising:
a sensor configured to generate a signal indicative of the load of the motor vehicle.

9. The motor vehicle as recited in claim 8, wherein the sensor includes a strain gauge mounted adjacent a rear axle of the motor vehicle.

10. The motor vehicle as recited in claim 8, wherein the sensor includes a transducer mounted adjacent a coil spring.

11. The motor vehicle as recited in claim 1, wherein the conspicuity lamp is one of a tail lamp and a center high-mount stop lamp.

12. The motor vehicle as recited in claim 1, wherein the motor vehicle is a pickup truck, and the load of the motor vehicle is a load in a cargo box of the pickup truck.

13. A method, comprising:
illuminating a conspicuity lamp in proportion to a load of a motor vehicle.

14. The method as recited in claim 13, wherein the step of illuminating the conspicuity lamp includes illuminating a surface area of the conspicuity lamp in proportion to the load of the motor vehicle.

15. The method as recited in claim 14, wherein the surface area of the conspicuity lamp is divided into sections, and wherein a number of sections of the conspicuity lamp are illuminated in proportion to the load of the motor vehicle.

16. The method as recited in claim 15, wherein, when the load of the motor vehicle is below a predetermined threshold, none of the sections of the conspicuity lamp are illuminated.

17. The method as recited in claim 15, wherein, when the load of the motor vehicle meets or exceeds a maximum rated load for the motor vehicle, all of the sections of the conspicuity lamp are illuminated.

18. The method as recited in claim 17, further comprising:
preventing normal vehicle operation when the load of the motor vehicle meets or exceeds the maximum rated load for the motor vehicle.

19. The method as recited in claim 13, wherein the load of the motor vehicle is determined based on a signal from a sensor, and wherein the sensor includes one of a strain gauge and a transducer.

20. The method as recited in claim 13, wherein the conspicuity lamp is one of a tail lamp and a center high-mount stop lamp.
